(19) United States
(12) Patent Application Publication
(10) Pub. No.: US 2019/0234646 A1
(43) Pub. Date: Aug. 1, 2019

(54) DUCT DAMPER

(71) Applicant: Dae Wan SEO, Yongin-si, Gyeonggi-do (KR)

(72) Inventor: Dae Wan SEO, Yongin-si, Gyeonggi-do (KR)

(21) Appl. No.: 16/341,234

(22) PCT Filed: Oct. 12, 2017
(86) PCT No.: PCT/KR2017/011239

§ 371 Date: Apr. 11, 2019

(30) Foreign Application Priority Data
Oct. 12, 2016 (KR) 10-2016-0132294

(51) Int. Cl. F24F 13/10; F24F 13/02; F24F 13/24; F16K 15/03

(52) U.S. Cl. CPC F24F 13/105; F24F 13/02; F16K 15/036; F16K 15/031; F24F 13/24

(57) ABSTRACT

Provided is a duct damper comprising: a hollow housing provided inside the duct so as to enable ventilation; a blocking plate provided in the housing and opening and closing the hollow; a fastener detachably fixing the blocking plate to the housing; and shape maintaining members respectively provided on the sides of the blocking plate so as to respectively maintain half of the shape formed by the blocking plate. According to the present invention, even if both sides of the blocking plate are bent with a center bar as an axis, since the shape maintaining members half and half support the both sides of the blocking plate, respectively, so as to maintain the shape, vibrations are not generated at either side of the blocking plate, thereby preventing noise.

### TECHNICAL FIELD

The present invention relates to a duct damper, and more particularly to a duct damper which effectively prevents noise, which may be caused when the pressure of exhausted air becomes higher while increasing the mechanical life span and shielding performance thereof by forming the damper provided in a duct of a soft material.

### BACKGROUND ART

Ventilation refers to exchange of interior air and air outside a window. The objective of ventilation is to renew dirty air and remove heat, moisture, and the like. Here, the dirty air refers to air in which a specific limit or more of amount of small, fume, dust, germs, moisture, gas, and the like, which are not suitable for the purpose of the user of a place. In order to determine whether the air state of the interior, in which a person is located, is good or bad, a concentration of carbon gas (carbon dioxide) in the air is used as an index.

For ventilation, such a ventilation system is provided, and ventilation is divided into natural ventilation which used a window or a ventilation passage (duct) and mechanical ventilation (compulsory ventilation) which uses a blower or a ventilation fan. Then, the ventilation system uses a damper in the interior of a duct to block air, which is introduced from the outside reversely.

In general, a damper is a device which is installed in a smoke duct of a boiler or the like, or an air passage of an air adjusting apparatus, that is, in the interior of a duct to adjust the amount of discharged smoke or the amount of air, and a backdraft prevention damper for discharging interior air to the outside or blocking air introduced reversely is mainly used.

As disclosed in Korean Patent No. 10-0699599 (2007 Mar. 19), a conventional damper includes a cylindrical body having a rotary shaft, a half-moon shaped opening/closing plate which is divided to opposite sides fitted with a rotary shaft, a fixing member having a specific width, and an elevation member having a bent plate, which is fixed by a screw shaft. Through the conventional configuration, the opening/closing plate is smoothly opened and closed as the elevation member is lifted or lowered through rotation of the screw shaft, and noise due to vibration is not caused as a frictional resistance part is remarkably decreased when a portion of air flows to the central side of the opening/closing plate.

However, the conventional damper includes the above-mentioned configurations, that is, a rotary shaft, a cylindrical body, an opening/closing plate divided to opposite sides, a fixing member, a screw shaft, and an elevation member, and the configurations thereof are complex, it is not easy to manufacture and install them, and the operations thereof is very difficult. Further, according to the conventional damper, when the cylindrical body is opened while the opening/closing plate is lifted, the opening/closing plate collides with the elevation member on the bent plate, contacting the elevation member. Accordingly, according to the conventional damper, the opening/closing plate collides the elevation damper while being opened, causing noise due to contact whenever the opening/closing plate contacts the elevation damper. Moreover, the conventional damper may cause noise while colliding with a boss portion illustrated in the cylindrical body while contacting the boss portion as the damper is closed.

Accordingly, in order to solve the above-mentioned problems, the conventional damper employs a soft material as the material of the opening/closing plate which opens and closes the cylindrical body so that noise is not caused even when the opening/closing plate collides with the elevation member or the boss. Further, the opening/closing plate does not employ a complex structure which is fitted with the rotary shaft while the opposite sides thereof are divided to open and close the cylindrical body, and has an integrally formed disk-shaped structure of a soft material and is improved to open and close the cylindrical body while the opposite sides of the disk shape is bent without using a separate hinge structure, such as the above-mentioned rotary shaft.

As disclosed in Korean Patent Application Publication No. 10-2009-0059557 (2009 Jun. 11), the conventional soft membrane damper includes a body having a seating member and a reinforcing member, a fixed body fitted with the outside of the body, a damper plate having a weight part and a seating/reinforcing part, and a fixing member which couples the damper plate to the body. Through the conventional configuration, the damper plate does not vibrate in a low-pressure state or a high-speed state in which the speed of wind in the interior of the pipe passage is high.

However, in the damper according to the document, a basic solution for a problem of causing vibration when a portion between a weight part and a seating/reinforcing part of the damper plate is bent when the opposite sides of the damper plate are bent in a low-pressure state or in a high-speed state of wind cannot be suggested. In detail, the conventional plate maintains the shape thereof while supporting the surrounding parts due to the weight part and the seating/reinforcing part, and the weight part and the seating/reinforcing part are individual configurations which do not extend from each other and are separated so that a portion, which is not influenced by the weight part and the seating/reinforcing part fails to maintain its shape and maintains the form of a soft thin membrane (silicon, or an elastic material) which is easily bent or folded. Accordingly, because a portion of the damper plate fails to receive the force supported by the weight part or the seating/reinforcing part, the soft portion consistently vibrates while being easily bent or folded by the flowing fluid. That is, according to the conventional damper, for example, disclosed in the prior document, a Karman vortex phenomenon in which the above-mentioned portion consistently vibrates occurs, and noise is caused by a contact phenomenon in which the facing opposite sides of the damper plate collide with each other while vibrating. In addition, when the bent or folded portion of the conventional consistently vibrates, it may be damaged. For example, it may be torn.

Further, as described above, according to the conventional damper, because the weight part and the seating/reinforcing part of the damper plate are individually configured to be separated from each other and do not receive the forces supporting each other, a portion of the damper plate is bent or folded when the damper plate is seated on the body so that the equilibrium state is not maintained, whereby an aperture is caused between the damper plate and the body so that a backdraft phenomenon in which exterior air enters into the damper plate occurs.

Further, according to the conventional damper, it is necessary to form a radial reinforcing member which supports the damper plate toward the inner side of the body as a configuration for maintaining the equilibrium state of the above-mentioned damper plate. That is, it is necessary to install the radial reinforcing member in the body through injection molding or separately, and manufacturing costs and manufacturing time are severely consumed.

### DISCLOSURE

### Technical Problem

The present invention has been made in an effort to solve the above-mentioned problems, and provides a duct damper which can prevent vibration of a blocking plate by maintaining the shapes of opposite sides of the blocking plate when the opposite sides of the blocking plate are bent with respect to the center line of the blocking plate.

The present invention also provides a duct damper which can detachably fix a blocking plate to the interior of a housing by a fastener.

The present invention also provides a duct damper which can prevent a blocking plate from reversely moving to the inside of a housing by supporting an edge of the blocking plate.

The present invention also provides a duct damper which can naturally bend opposite sides of a blocking plate bent in one direction by a fluid in an opposite direction by the self-weight of the blocking plate.

The present invention also provides a duct damper which can further reinforce a fastening force between a housing and a blocking plate which are fixed by a fastener, by providing a fixing bar.

The present invention also provides a duct damper which can bend opposite sides of a blocking plate while taking a center bar as an axis.

The present invention also provides a duct damper which can suppress deformation of the shape of a blocking plate by using a support bar.

The present invention also provides a duct damper which can partially support a surface of a blocking plate by providing a plurality of radial ribs extending from a center bar to an end of an edge of the blocking plate, by a support bar.

The present invention also provides a duct damper which can support an entire surface of an edge of a blocking plate by using a rib extending from a center bar along an edge of the blocking plate, by a support bar.

The present invention also provides a duct damper which can improve the efficiency of bending a blocking plate in an opposite direction by using the gravity, by using a weight member.

The present invention also provides a duct damper which can suitably seat an edge of a blocking plate in the interior of a housing by providing a stepped state at a lower end of the blocking plate.

The present invention also provides a duct damper which can prevent opposite sides of a blocking plate from reversely moving into a housing by supporting a lower surface of the blocking plate.

The present invention also provides a duct damper which can integrally provide a shape maintaining member in the interior of a blocking plate by inserting the shape maintaining member into the blocking plate.

The present invention also provides a duct damper which can integrally couple a blocking plate and a shape maintaining member by integrally forming the blocking plate and the shape maintaining member of the same material or integrally coupling the blocking plate and the shape maintaining member of different material.

The present invention also provides a duct damper which can form a blocking plate and a shape maintaining member of the same soft material.

The present invention also provides a duct damper which can form a blocking plate of a soft material and form a shape maintaining member of a material that is different from that of the blocking plate.

The present invention also provides a duct damper which can prevent opposites of a blocking plate from colliding with each other, contacting each other, by providing an inclined structure which becomes lower from a center bar to an end of a support.

### Technical Solution

In accordance with an aspect of the present invention, there is provided a duct damper comprising: a housing having a hollow and installed in the interior of a duct such that air ventilates through the housing; a blocking plate of a soft material, which is provided in the housing to open and close the hollow; a fastener configured to fix the blocking plate to the housing; and a shape maintaining member configured to maintain the shape of a soft portion of the blocking plate, which is not fixed by the fastener.

The housing may include: a seating frame provided in a state in which the seating frame crosses the interior of the housing to be divided into halves and having a predetermined width such that the blocking plate is seated on the seating frame; and a stepped seating seat protruding along an inner edge of the housing such that an edge of the blocking plate seated on the seating fame is seated on the seating seat.

Further, it is preferable that the seating frame and the seating seat are provided to be inclined with respect to the vertical direction of the axial direction formed by the housing, in the interior of the housing, such that the housing is automatically closed while the opposite sides of the blocking plate are bent in an opposite direction by the self-weight of the blocking plate after the housing is opened while the opposite sides of the blocking plate are bent in one direction by the fluid flowing in the housing.

Further, the fastener may include: a plurality of bosses protruding along a lengthwise direction of the seating frame; and hole-shaped coupling holes formed to pass through the blocking plate to correspond to the coupling bosses and coupled in a state in which the coupling bosses pass through the coupling holes.

The coupling boss may include a hooked hook an end of which is stopped by a surface of the blocking plate while the coupling boss passes through the coupling hole.

Further, the fastener may further include a fixing bar which forms a shape corresponding to the seating part and fixes the blocking plate to the seating part while the blocking plate is adhered while the blocking plate is coupled to the coupling boss.

Meanwhile, the fixing bar may further include a damage preventing part which prevents a concentrated load while surface-contacting a portion of the blocking plate.

Further, the shape maintaining member may include: a bar-shaped center bar provided to be long in a line form along a center line direction of the blocking plate on opposite sides of the blocking plate, which are spaced apart from each other by a predetermined interval in a horizontal direction from the center line of the blocking plate to be symmetrical to each other, and configured to provide a reference axis, by which the blocking plate is bent; and a support bar extending from the center bar to be integrally formed to an edge of the blocking plate and configured to suppressing deformation of the shape of the blocking plate.

Meanwhile, the support bar may include: a plurality of ribs extending from the center bar to an end of the edge of the blocking plate, radially formed from the center bar, and configured to partially support a surface of the blocking plate.

Meanwhile, the support bar may include: a rib extending from the center bar along the edge of the blocking plate, provided to have a shape corresponding to the edge of the blocking plate, and configured to support the entire edge of the blocking plate.

Further, the duct damper may further comprise a weight member provided on a surface of the blocking plate that is opposite to a surface of the blocking plate, which is provided with the shape maintaining member, and configured to provide a weight to the blocking plate.

Then, the blocking plate may further include: a stepped step formed at a lower end of the edge of the blocking plate as the weight member corresponds to the shape maintaining member and is spaced apart from an inner side of the edge of the blocking plate by a predetermined interval.

Further, the duct damper may further comprise a net-shaped auxiliary frame formed in the interiors of opposite sides of the housing divided by the seating frame and configured to support a lower portion of the blocking plate to prevent reverse movement of the blocking plate.

Meanwhile, the shape maintaining member may be integrally molded with the center bar and the support bar by inserting the center bar and the support bar into the blocking plate.

Meanwhile, the blocking plate and the shape maintaining member may be integrally formed of the same material or may be formed of different materials to be integrally coupled to each other.

Meanwhile, the blocking plate and the shape maintaining member may be formed of the same soft material.

Meanwhile, the blocking plate may be formed of a soft material, and the shape maintaining member may be formed of a material that is different from that of the blocking plate.

Further, the shape maintaining member may further include a contact prevention part having an inclined structure, which becomes lower from the center bar to an end of the supporter to prevent the opposite sides of the blocking plate, which are bent with respect to the center bar from contacting each other.

### Advantageous Effects

According to the duct damper according to the present invention, because the shape maintaining member supports the opposite sides of the blocking plate by halves to maintain the shape of the blocking plate even through the opposite sides of the blocking plate are bent while taking the center bar as an axis, the opposite sides of the blocking plate do not vibrate and this noise due to vibration can be prevented. In addition, the blocking plate can prevent damage caused by conventional vibration in advance.

Further, because the blocking plate is detachably fixed by the fastener, the blocking plate can be easily manufactured and maintained/repaired.

Further, because opposite edges of the blocking plate are supported by the seating seat, the blocking plate can be prevented from moving reversely into the housing. Then, because the opposite shapes of the blocking plate are maintained by the above-mentioned shape maintaining member, it is easy to manufacture the duct damper and the manufacturing costs and manufacturing time can be effectively reduced by excluding a separate shape or a separate member for preventing the opposite sides of the blocking plate from reversely moving into the housing.

Further, because a load provided due to the weight of the shape maintaining member is applied to an edge of the blocking plate, the blocking plate can be easily adhered to the seating seat. That is, the sealing performance of the blocking plate which closes the hollow of the housing can be improved.

Further, because the blocking plate is automatically bent again in the opposite direction (the reverse direction) by the self-weight of the blocking plate even though the blocking plate is bent in the one direction (the forward direction) as the blocking plate is supported in a state in which the seating fame and the seating seat are inclined in the interior of the housing, the safety of opening and closing the hollow of the housing by the blocking plate can be improved, and because a separate member for opening and closing the housing is not necessary, it is easy to manufacture the duct damper and the manufacturing and manufacturing time of the duct damper can be effectively reduced.

Further, the faster can easily couple the blocking plate to the interior of the housing by using a simple structure of the coupling bosses and the coupling holes.

Then, because the coupling bosses are hook-shaped hooks, the coupling bosses can be fixed while being easily stopped as long as the coupling bosses are inserted into the coupling holes.

In addition, because the fastening is reinforced by supporting the blocking plate fixed to the seating frame by the fixing bar in an adhered state, the blocking plate can be fixed to the housing more effectively.

Further, the opposite sides of the blocking plate while taking the center bars provided on the opposite sides of the blocking plate as the reference axes are easily bent, and the fluid flowing into the interior of the housing can smoothly flow to the opposite sides of the blocking plate while not being biased to one side.

Further, a phenomenon, in which the remaining parts, except for the center bar part at which the opposite sides of the blocking plate are bent, can be easily prevented by the support bar.

Meanwhile, because the plurality of ribs radially extending from the support, that is, the center bar to an end of the edge of the blocking plate are provided, the shapes of the opposite sides of the blocking plate can be effectively maintained even though the surface of the blocking plate is partially supported.

Meanwhile, the shapes of the opposite sides of the blocking plate can be maintained more effectively by supporting the entire surface of the edge of the blocking plate by using the rib extending from the support, that is, the center bar along the edge of the blocking plate.

Further, because the support bar maintains the shape of the blocking plate by suppressing the deformation of the shape of the blocking plate, a Karman vortex phenomenon in which the soft blocking plate may be bent or folded, that is, flutters due to the flows of the fluid can be blocked and thus noise can be blocked in advance.

Further, because the load of the blocking plate is reinforced by providing the weight member which provides a weight to the opposite surface of the blocking plate provided with the shape maintaining member, the sealing performance of the blocking plate for closing the hollow of the housing can be improved more effectively.

Further, an edge of the lower end of the blocking plate is easily seated on the seating seat by the stepped step provided in the blocking plate, and then, because the weight is guided to the inside of the seating seat while not being stopped by the seating seat, it can naturally provide a weight to the blocking plate.

Further, because the lower surface of the blocking plate is supported by the auxiliary frame in an auxiliary way, the opposite sides of the blocking plate can be more effectively prevented from moving reversely into the housing.

Further, because the shape maintaining member provides a contact prevention part having an inclined structure which becomes lower from the center bar to an end of the support, a contact phenomenon in which the shape maintaining members provided on the opposite sides of the blocking plate collides with each other can be restricted and this noise can be prevented in advance.

Meanwhile, because the blocking plate and the shape maintaining member are integrally insert-molded of the same material, it is easy to manufacture the duct damper.

Meanwhile, because the blocking plate and the shape maintaining member are integrally coupled to each other by a separate means even though the blocking plate and the shape maintaining member are formed of different materials, an effect of mutually complementing each other can be provided by various materials.

In detail, the hollow of the interior of the housing is completely sealed by the blocking plate of a soft material, and then, a mutual complementary effect of easily maintaining the shape of the blocking plate while suppressing the deformation of the shape of the blocking plate by the shape maintaining member of a hard material.

Further, because the shape maintaining member is integrally insert-molded into the blocking plate, the duct damper can be easily manufactured and the shape maintaining member and the blocking plate can be easily integrally coupled to each other without using a separate coupling means.

### DESCRIPTION OF THE INVENTION

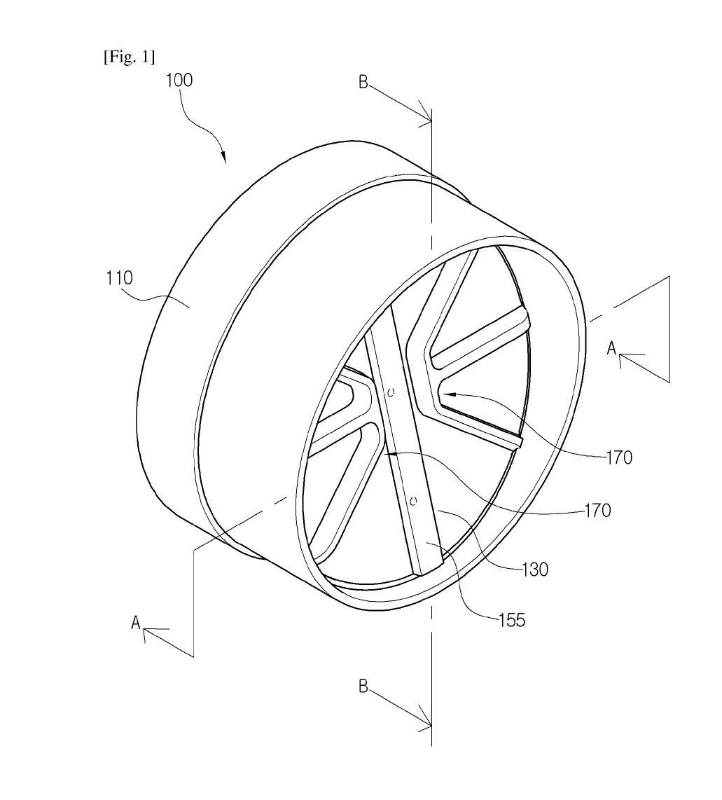

FIG. 1 is a view illustrating an overall appearance of a duct damper according to an embodiment of the present invention.

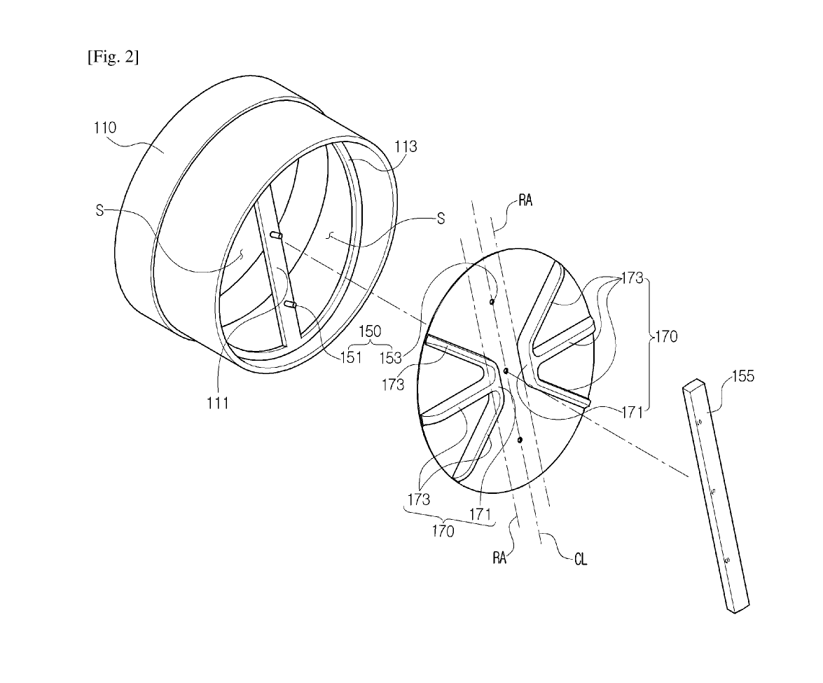

FIG. 2 is an exploded view illustrating a configuration of FIG. 1.

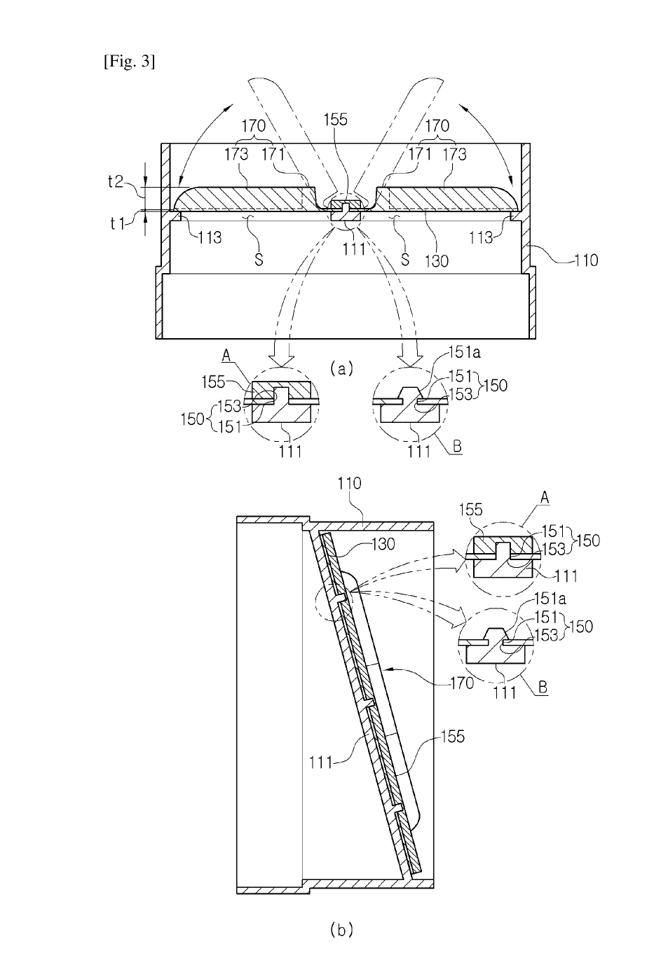

FIG. 3 illustrates sectional views of FIG. 1, taken along A-A and B-B.

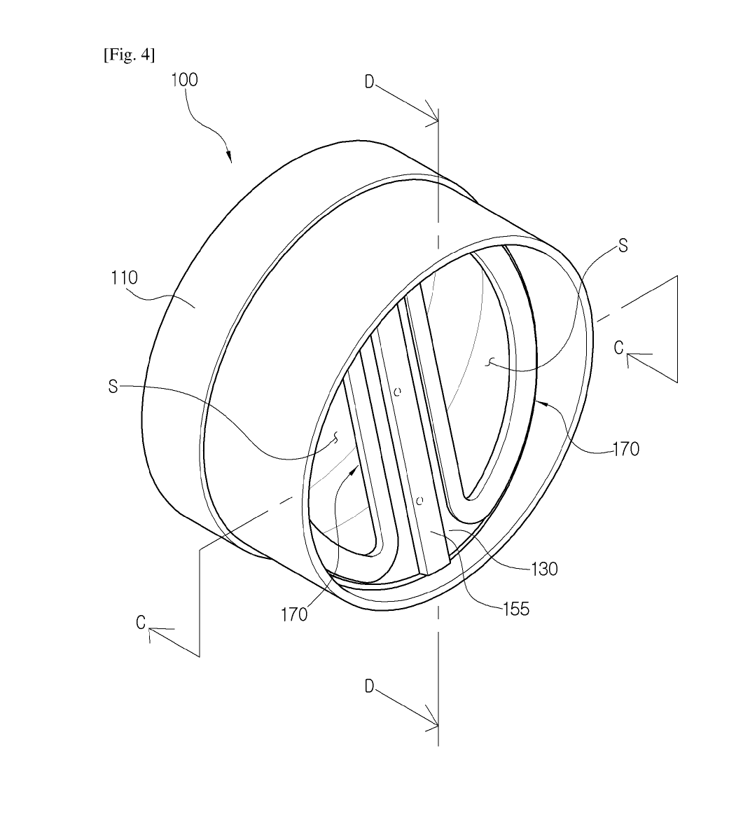

FIG. 4 is a view illustrating an overall appearance of a duct damper according to another embodiment of the present invention.

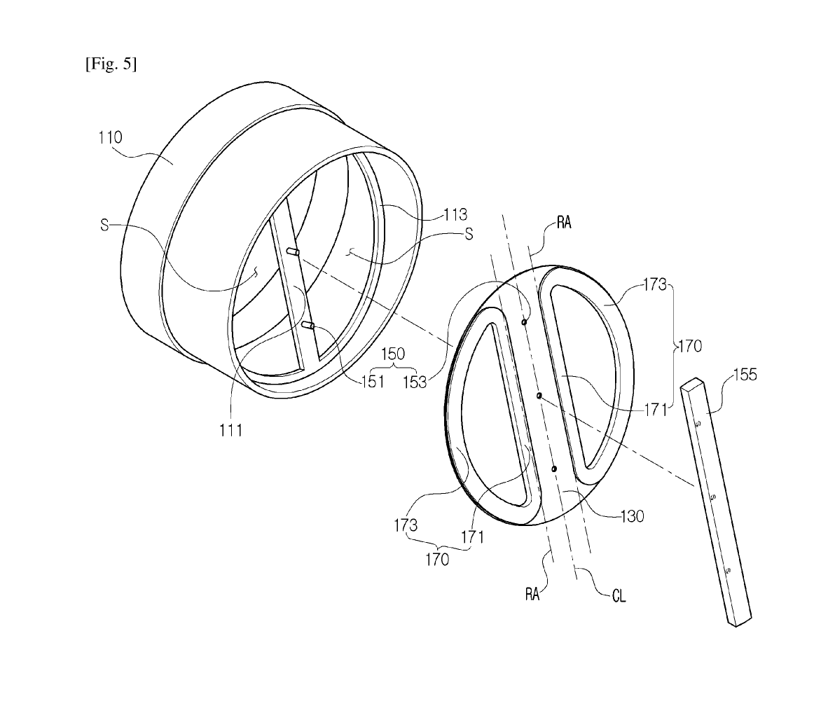

FIG. 5 is an exploded view illustrating a configuration of FIG. 4.

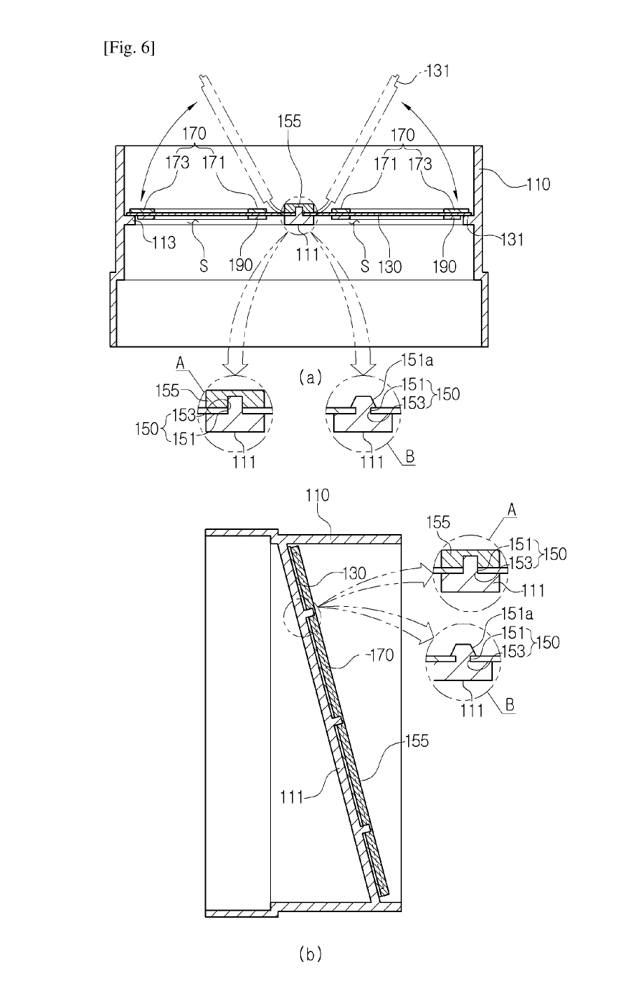

FIG. 6 illustrates sectional views of FIG. 4, taken along C-C and D-D.

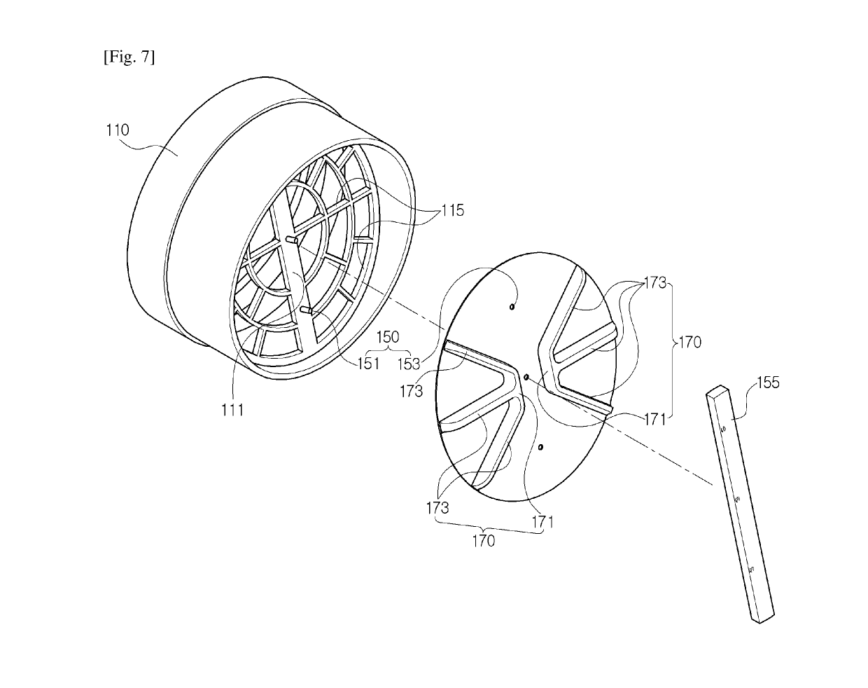

FIG. 7 is a view illustrating an overall appearance of a duct damper according to another embodiment of the present invention.

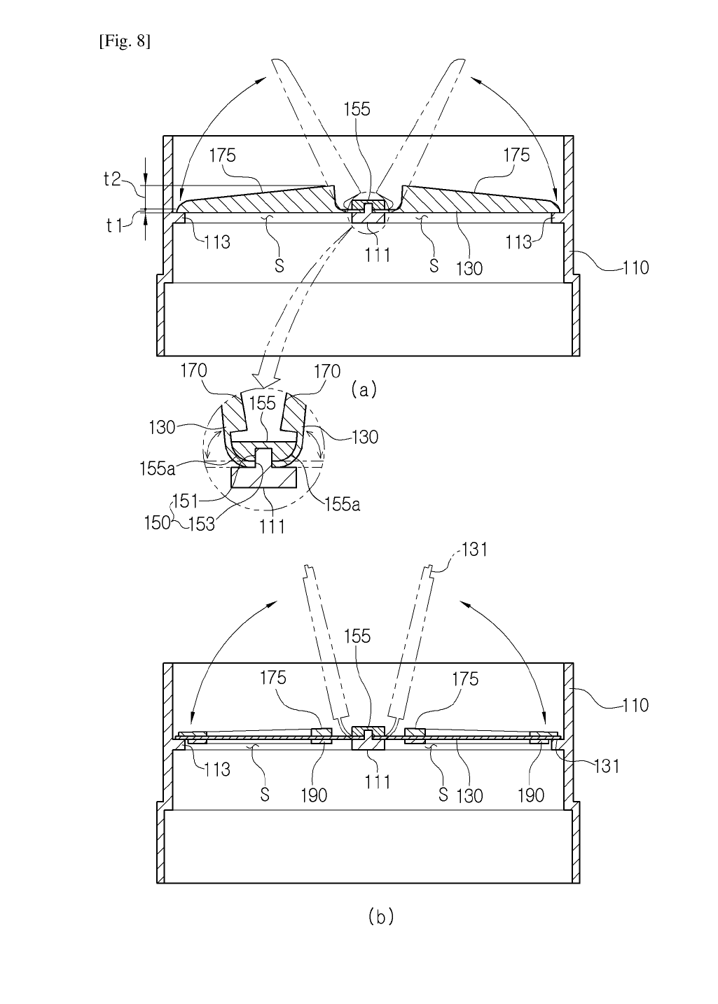

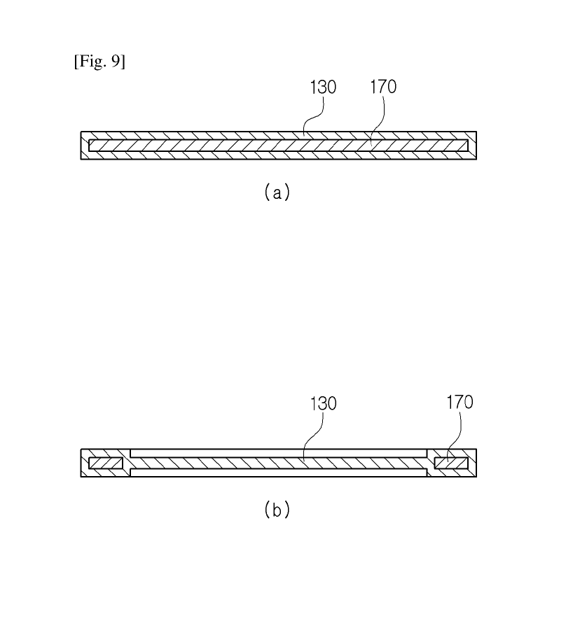

FIGS. 8 and 9 are views illustrating an overall appearance of a duct damper according to another embodiment of the present invention.

### DESCRIPTION OF MAIN REFERENCE NUMERALS

100: Duct damper
110: Housing
111: Seating frame
113: Seating seat
115: Auxiliary frame
130: Blocking plate
131: Step
150: Fastener
151: Coupling boss
151a: Hook
153: Coupling hole
155: Fixing bar
170: Shape maintaining member
171: Center bar
173: Support bar
175: Contact prevention part
190: Weight member
S: Hollow

### BEST MODE

Hereinafter, exemplary embodiments of the present invention will be described in detail with reference to the accompanying drawings.

All the terms of the specification are the same as the general meanings of the terms, which are understood by an ordinary person in the art to which the present invention pertains, and if the terms used in the specification do not agree with the general meanings of the terms, their meanings follows the definitions used in the specification.

Meanwhile, the configurations or systems of the apparatus, which will be described below, are provided only to describe the embodiments of the present invention and are provided not to define the scope of the present invention, and the reference numerals, which are used over the specification, denote the same elements.

A duct damper 100 according to the present invention includes a housing 110, a blocking plate 130, a fastener 150, and a shape maintaining member 170

The housing 110 is an element installed in the interior of a duct, and as illustrated in FIG. 2, is provided with a hollow S which passes through the interior of the housing 110. The overall shape of the housing 110 preferably is a cylindrical shape as illustrated, but may be various shapes, such as a rectangular shape and a polygonal shape, which correspond to the shape of the duct. Accordingly, the housing 110 may be easily installed in the interior of the duct regardless of the shape of the duct.

The housing 110 functions as a passage, through which contaminated air in an interior, such as the interior of a room, a bathroom, or a kitchen, is discharged to the outside, and blocks exterior air from being introduced into the interior through the blocking plate 130, which will be described below. The housing 110 includes a seating frame 111 and a seating seat 113 to install the blocking plate 130 in the interior thereof.

The seating frame 111 is an element, on which the blocking plate 130 is seated, and as illustrated in FIG. 2, is provided in a state in which the seating frame 111 crosses the interior of the housing 110 to divide the hollow S of the housing 110 into halves. As illustrated, the seating frame 111 has a bar shape having a specific width. Accordingly, as illustrated in FIGS. 1 and 3, a center line (CL) portion of the blocking plate 130, which will be described below, is seated on the seating frame 111. Accordingly, the blocking plate 130 constitutes a state in which the blocking plate 130 is provided in the interior of the housing 110 by the seating frame 111. The seating seat 113 is an element, on which an edge of the blocking plate 130 is seated, and as illustrated in FIG. 2, protrudes along an inner edge of the housing 110. As illustrated, the seating seat 113 has a shape corresponding to the shape of the housing 110, and as illustrated in FIG. 2, has an annular shape and has the form of a protrusion which protrudes by a predetermined length. Accordingly, as illustrated in FIGS. 1 and 3A, an edge portion of the blocking plate 130, which will be described below, is seated on the seating seat 113. Accordingly, opposite sides of the blocking plate 130 are supported by the seating seat 113, and thus are prevented from reversely moving to the inner side of the housing 110. Here, the reverse movement means that the blocking plate 130 moves reversely in a direction that is opposite to a normal direction, and means that the opposite sides of the blocking plate 130 are bent to the inner side of the housing 110.

Meanwhile, the seating frame 111 and the seating seat 113, which have been described above, form inclined states as illustrated in FIGS. 2 and 3B. In detail, the seating frame 111 and the seating seat 113 are provided in a form in which the seating frame 111 and the seating seat 113 are inclined with respect to a vertical direction of the axial direction formed by the housing 110 in a state in which the seating frame 111 and the seating seat 113 are provided in the interior of the housing 110. Accordingly, because the seating frame 111 and the seating seat 113 provide an inclination to the blocking plate 130, which will be described, as illustrated, if flows of a fluid are not further generated after opposite sides of the blocking plate 130 are bent in one direction (a forward direction) by the flows of the fluid, which flows in the interior of the housing 110, the opposite sides of the blocking plate 130 are naturally bent in an opposite direction (a reverse direction or a gravitational direction). Then, because an edge portion of the blocking plate 130 is seated on the seating seat 113, which has been described above, the blocking plate 130 does not move reversely further into the interior of the housing 110 even though the opposite sides of the blocking plate 130 are bent in the opposite direction.

Meanwhile, the housing 110 may further include an auxiliary frame 115.

The auxiliary frame 115 is an element for supporting the blocking plate 130, and as illustrated in FIG. 7, is provided in the interiors of opposite sides of the hollow S divided by the seating frame 111. Then, the auxiliary frame 115 preferably forms a net shape. Accordingly, because the auxiliary frame 115 supports lower portions of the opposite sides of the blocking plate 130, the blocking plate 130 does not move reversely in the interior direction of the housing 110. However, the duct damper 100 according to the present invention can sufficiently prevent the blocking plate 130 from moving reversely in the interior direction of the housing 110 even when the auxiliary frame 115 is not included. In a short description, because the opposite sides of the blocking plate 130 are supported by the seating seat 113 when an edge of the blocking plate 130 is seated on the seating seat 113 in a state in which the opposite sides of the blocking plate 130 are maintained by the shape maintaining member 170, the blocking plate 130 does not move reversely into the interior of the housing 110, and the details will be described below.

The blocking plate 130 is an element for opening and closing the hollow S, which passes through the interior of the housing 110, and as illustrated in FIG. 2, has a shape corresponding to the shape of the housing 110 and is seated on the seating frame 111 and the seating seat 113, which have been described above. Accordingly, the blocking plate 130 may open or close the hollow S of the housing 110. The preferable method for opening and closing the blocking plate 130 will be described below.

Here, it is preferable that the blocking plate 130 includes a membrane formed of a soft material, such as silicon or rubber, which has a soft property. Accordingly, opposite sides of the blocking plate 130 may be naturally bent in one direction or an opposite direction without using a separate hinge unit by the flows of the flow, which passes through the hollow S of the housing 110 divided into halves as described above, in a state in which the blocking plate 130 is fixed to the seating frame 111 by the fastener 150, which will be described below. Then, because the blocking plate 130 is formed of a soft material, noise is generated due to a Karman vortex phenomenon in which the opposite sides of the blocking plate 130 flutters while being bent or folded when the flows of the fluid is severe, and the phenomenon can be prevented in advance by the shape maintaining member 170, which will be described below, and a detailed description thereof will be described below.

The fastener 150 is an element which fixes the blocking plate 130 to the housing 110, and as illustrated in FIG. 2, includes a plurality of coupling boss 151 and a plurality of coupling holes 153.

The coupling boss is an element coupled to the blocking plate 130 while passing through the blocking plate 130, and as illustrated in FIG. 2, has a boss shape which protrudes from one surface of the seating frame 111. A plurality of coupling bosses 151 are formed along a lengthwise direction of the seating frame 111 at a predetermined interval.

Accordingly, as illustrated in FIG. 1, the coupling bosses 151 are coupled to a portion of the blocking plate 130 seated on the seating frame 111 such that the blocking plate 130 does not deviate from the seating frame 111.

Meanwhile, each of the coupling bosses 151 may include a hook 151a.

As illustrated in the enlarged view B of FIG. 3, the hook 151a has a hook shape in which an end of the hook 151a is hooked by a surface of the blocking plate 130 in a state in which the hook 151a passes through the corresponding coupling hole 153, which will be described below. Accordingly, because the hooked portion of the hook 151a is hooked by the surface of the blocking plate 130 while passing through the blocking plate 130, the blocking plate 130 can be easily fixed to the seating frame 111 without using a separate coupling unit (a fixing bar 155 which will be described below).

The coupling holes 153 are elements, into which the coupling bosses 151 are inserted, and as illustrated in FIG. 2, are formed in the form of holes at portions, preferably, the center line (CL) portions of the blocking plate 130. The coupling holes 153 have the shapes corresponding to the number and the interval of the coupling bosses 151, which will be described below. Accordingly, the coupling holes 153 determine locations at which the blocking plate 130 is seated on the seating frame 111, and then, provide passages, through which the coupling bosses 151 passes through the blocking plate 130.

Meanwhile, the fastener 150 may further include a fixing bar 155.

The fixing bar 155 is an element which reinforces the fastening force of the fastener 150, and as illustrated in FIG. 2, has a bar shape having a predetermined thickness and a predetermined length. Preferably, the fixing bar 155 has a shape corresponding to the seating frame 111, which has been described above. As illustrated in the enlarged view A of FIG. 3 and the enlarged view A of FIG. 6, the fixing bar 155 is fixed to the coupling bosses 151, which pass through the blocking plate 130. Accordingly, the fixing bar 155 can further reinforce the fastening force of the fastener 150, which fixes the blocking plate 130 to the seating frame 111, in a state in which the blocking plate 130 is supported in an adherence state once more.

Meanwhile, as illustrated in FIG. 8, when opposite sides of a lower portion of the fixing bar 155 form corners, a concentrated load phenomenon in which a load is intensively applied to contact portions while portions of opposite sides of the bent blocking plate 130 are pressed by the corners in a point-contact form, and thus a damage, such as tearing, to the blocking plate 130 cans be caused. The fixing bar 155 may further include a damage preventing part 155a for preventing a concentrated load from being applied to a portion of the blocking plate 130.

For example, as illustrated in the enlarged view of FIG. 8A, the damage preventing part 155a may have round shapes at opposite ends of a lower end of the fixing bar 155. Accordingly, when the opposite sides of the blocking plate 130 are bent with respect to the fixing bar 155 in a state in which the blocking plate 130 is fixed by the fixing bar 155 as illustrated, portions of opposite sides of the blocking plate 130 come to surface-contact the damage preventing part 155a formed in the fixing bar 155 instead of point-contacting the damage preventing part 155a and thus a concentrated load phenomenon in which a load is intensively applied to the portions of the opposite sides of the blocking plate 130 is not caused. That is, because no concentrated load is caused in the portions of the opposite sides of the blocking plate 130, damage to the blocking plate 130 due to a concentrated load can be prevented in advance.

The shape maintaining member 170 is an element for maintaining the shape of the blocking plate 130, and maintains the shape of the remaining soft portions of the blocking plate 130, which are not fixed by the fastener 150, which has been described above. Preferably, the shape maintaining members 170 are provided on opposite sides of the blocking member 130, respectively, and can maintain the shapes of the opposite sides of the blocking plate 130 in the same way.

Here, the shape maintaining member 170 may be formed of a soft material, such as silicon or rubber, which has the same soft property as the blocking plate 130, which has been described above. Accordingly, because the shape maintaining member 170 is formed of the same material as the blocking plate 130, which has been described above, it may be easily integrally formed with the blocking plate 130 as illustrated in FIGS. 1 to 3. Further, the shape maintaining member 170 may be formed of a hard material, such as urethane or plastic, which has a hard and solid property, which is different from the property of the blocking plate 130, which has been described above. Accordingly, because the shape maintaining member 170 is formed of a material, which is different from that of the blocking plate 130, which has been described above, it may be integrally formed with the blocking plate 130 by a separate coupling means (welding, bonding, or the like) as illustrated in FIG. 6. Then, as illustrated in FIG. 9, the shape maintaining member 170 may be integrally formed with the blocking plate 130 through insert molding, in which the shape maintaining member 170 is inserted into the blocking plate 130.

Meanwhile, as illustrated in FIGS. 3A and 6A, because the shape maintaining member 170 has a thickness (t2) that is larger than the thickness (t1) of the blocking plate 130, it may be formed of a material, which is harder than the blocking plate 130, even though it is formed of the same soft material, and can easily maintain the shape thereof while supporting a surface of the blocking plate 130. The shape maintaining member 170 will be described in more detail on the basis of various following embodiments.

### First Embodiment

As illustrated in FIGS. 2 and 3, the shape maintaining member 170 includes a center bar 171 and a support bar 173 which is integrally formed with the blocking plate 130.

The center bar 171 is an element which provides a reference axis (RA), by which the blocking plate 130 is bent, and as illustrated in FIG. 2, protrudes in a line form along the center line (CL) direction of the blocking plate 130 in a state in which the center bar 171 is provided at portions of the blocking plate 130, which are spaced apart from the center line (CL) of the blocking plate 130 horizontally, that is, the opposite sides of the blocking plate 130. The center bar 171 has a bar shape having a predetermined width. Accordingly, the center bar 171 supports a portion of a surface of the blocking plate 130 along a lengthwise direction thereof. Accordingly, only the shape of a portion of the blocking plate 130, at which the center bar 171 is formed, is maintained, and only a portion of the blocking plate 130, at which seating frame 111, which has been described above, is seated, that is, a soft portion between the center line (CL) portion and the portion at which the center bar 171 is bent. That is, the blocking plate 130 is bent along the reference axis (RA) provided while the center bar 171 is formed.

The support bar 173 is an element which partially supports the shape of the blocking plate 130, and as illustrated in FIG. 2, extends from the center bar 171, which has been described above, and protrudes to an end of an edge of the blocking plate 130. As illustrated, the support bar 173 has a plurality of ribs provided straight radially from the center bar 171. Then, the ribs have bar shapes having a predetermined width, and partially support a surface of the blocking plate 130 while protruding radially. Accordingly, even though the shapes of the portions of the blocking plate 130, at which the plurality of ribs are radially formed, is maintained, the soft portions of the blocking plate 130, at which the ribs are not provided, are sufficiently supported by the ribs and thus the deformation of the shape of the blocking plate 130 is suppressed. That is, because the support bar 173 has a minimum number of ribs which protrude radially, it can maintain the shape of the blocking plate 130 while suppressing the deformation of the shape of the blocking plate 130.

Because the shape maintaining member 170 of the first embodiment can bend the opposite sides of the blocking plate 130 while taking the center bar 171 as the reference axis (RA) and can maintain the blocking plate 130 from the center bar 171 to an end of the blocking plate 130 in the form of a plate by the support bar 173 so that noise can be prevented by preventing a Karman vortex phenomenon in which a portion of the blocking plate 130 flutters while being bent or folded when the flows of the fluid is severe and this can prevent noise

### Second Embodiment

As illustrated in FIGS. 5 and 6, the shape maintaining member 170 includes a center bar 171 and a support bar 173 which are integrally coupled to each other by a separate coupling means.

The center bar 171 is an element which provides a reference axis (RA), by which the blocking plate 130 is bent, and as illustrated in FIG. 5, protrudes along the center line (CL) direction of the blocking plate 130 in a state in which the center bar 171 is provided at portions of the blocking plate 130, which are spaced apart from the center line (CL) of the blocking plate 130 horizontally. The center bar 171 has the same configuration as the first embodiment, which has been described above, and a detailed description thereof will be omitted.

The support bar 173 is an element which supports the entire shape of the blocking plate 130, and as illustrated in FIG. 5, extends from an end of one side of the center bar 171, which has been described above, and extends to ends of the opposite side of the center bar 171 along a circumference of the edge of the blocking plate 130. The support bar 173 includes a rib corresponding to an edge of one side of the blocking plate 130. Then, because the rib supports the entire surface of the edge of the blocking plate 130 while extending along the edge of the blocking plate 130, it maintains the entire shape defined by the blocking plate 130. Accordingly, because the support bar 173 supports the entire surface of the edge of the blocking plate 130, it can easily maintain the entire shape defined by the soft blocking plate 130. That is, the support bar 173 can maintain the shape of the blocking plate 130 while suppressing the deformation of the shape of the blocking plate 130.

Because the shape maintaining member 170 of the second embodiment can bend opposite sides of the blocking plate 130 while taking the center bar 171 as the reference axis (RA) and can easily maintain the plate shape of the blocking plate 130 by supporting the entire edge of the blocking plate 130 from the center bar 171 by the support bar 173, it can prevent a Karman vortex phenomenon in which a portion of the blocking plate 130 flutters while being bent or folded when the flows of the fluid is severe and this can prevent noise.

Accordingly, as described in the first embodiment and the second embodiment, which have been described above, because the shape maintaining member 170 extends from the center bar 171 provided in the blocking plate 130 to an end of the blocking plate 130 through the support bar 173 and is provided on the opposite sides of the blocking plate 130, it may maintain the shape of the blocking plate 130 while the opposite sides of the blocking plate 130 are maintained in the form of a plate. That is, because the plate shape of the blocking plate 130 is maintained until the edge portion with respect to the center bar 171 by the shape maintaining member 170 and the shape maintaining member 170 is not provided until the center line (CL) with respect to the center bar 171, the blocking plate 130 is freely bent with while taking the center bar 171 as the reference axis (RA).

Meanwhile, the shape maintaining member 170 may further include a contact preventing part 175.

The contact preventing part 175 is an element for preventing a contact phenomenon in which the opposite sides of the blocking plate 130 collide with each other, and as illustrated in FIGS. 8A and 8B, forms an inclined surface having an inclination structure in which the shape maintaining member 170 becomes lower from an end of the center bar 171 to an end of the support bar 173. Accordingly, because the blocking plate 130 provides an inclined surface of an inclination structure in which the shape maintaining member 170 is inclined as a whole by the contact preventing part 175 even though the opposite sides of the blocking plate 130 are bent by the flow velocities of the fluid flowing in the interior of the housing 110 to be perpendicular to each other, the opposite sides of the blocking plate 130 do not contact each other. That is, because a contact phenomenon in which the opposite sides of the blocking plate 130 collide with each other is prevented, generation of noise can be prevented in advance.

Meanwhile, the damper for preventing noise according to the present invention may further include a weight member 190.

The weight member 190 is an element which provides a weight to the blocking plate 130, and as illustrated in FIG. 6, is provided on a surface of the blocking plate 130, which is opposite to the surface on which the shape maintaining member 170 is located, that is, a lower surface of the blocking plate 130. Accordingly, the weight member 190 reinforces a load applied to the blocking plate 130 by providing a predetermined weight to the blocking plate 130. That is, because the weight member 190 provides an additional weight to the blocking plate 130 in an auxiliary way as well as the weight provided by the shape maintaining member 170 provided in the blocking plate 130, it can improve sealing performance by the load applied to an edge of the blocking plate 130 more effectively by the shape maintaining member 170 when the hollow S of the housing 110 is closed by the blocking plate 130 as will be described below.

The weight member 190 forms a shape corresponding to the shape maintaining member 170, which has been described above, and as illustrated in FIG. 8, is spaced apart from the blocking plate 130 toward the inner side of an edge of the blocking plate 130 by a predetermined interval. Then, as illustrated, the blocking plate 130 is provided with a stepped step 131 from an edge of the blocking plate 130 to an end of the weight member 190. Accordingly, an edge of a lower end of the blocking plate 130 is easily seated on the seating seat 113 by the stepped step 131, and then, a weight can be provided while the weight member 190 is naturally guided into the seating seat 113 without the weight member 190 is not stopped by the seating frame 111.

Meanwhile, the shape maintaining member 170 and the weight member 190, which have been described above, can be easily coupled to each other by the fastener (not illustrated) in a state in which the blocking plate 130 is disposed between the shape maintaining member 170 and the weight member 190. For example, the fastener (not illustrated) forms a boss on one surface of the shape maintaining member 170, and forms a hole-shaped holder on one surface of the weight member 190, that is, one surface of the weight member 190, which faces the shape maintaining member 170, such that the weight member 190 and the blocking plate 130 may be easily coupled to each other through press-fitting while the soft blocking plate 130 is supported. However, a method in which the shape maintaining member 170 and the weight member 190 are coupled to each other by the fastener (not illustrated), which has been described above, is not limited, and the shape maintaining member 170 and the weight member 90 can be easily coupled to each other in various forms, such as a separate adhesive, thermal fusion, a fastening means, and the like.

An operation of opening and closing the hollow S of the housing 110 by using the duct damper 100 having the above-mentioned structure will be described as follows.

First, the opposite sides of the blocking plate 130 are pushed away as illustrated in FIGS. 3A and 6A while the fluid generated in the interior of the housing 110 flows to the outside of the housing 110. Then, the blocking plate 130 opens the opposite sides of the hollow S of the housing 110 while the opposite sides of the blocking plate 130, except for the center line (CL) portion are bent in one direction (an outward direction or a forward direction) of the housing 110 because the center line (CL) portion of the blocking plate 130 is fixed to the seating frame 111. Because the blocking plate 130 is formed of a soft material from the center bar 171 to the center line (CL) portion, a bent state can be formed by a flowing force of the fluid as described above without using a separate hinge unit. Then, the opposite sides of the blocking plate 130 are bent by the center bar 171 which provides the reference axis (RA) while the plate shape of the blocking plate 130 is maintained by the shape maintaining member 170. Accordingly, when the interior fluid flows to the outside, the blocking plate 130 opens the hollow S while the opposite sides of the blocking plate 130, which blocks the hollow S, are naturally bent in the outward direction (a forward direction) by the flows of the fluid. Then, because a Karman vortex phenomenon in which the opposite sides of the blocking plate 130 flutters while being bent or folded is prevented by the support bar 173, the hollow S can be opened without causing noise. That is, the blocking plate 130 can discharge the contaminated air, which is generated in an interior, that is, an interior of a room, a bathroom, a kitchen, to the outside without causing noise.

Next, when further flows of the fluid are not generated after the air generated in the interior of the housing 110 is discharged to the outside, as illustrated in FIGS. 3B and 6B, the blocking plate 130 forms an inclination state by the seating frame 111 and the seating seat 113, and the opposite sides of the blocking plate 130 are naturally bent in an opposite direction (a reverse direction or a gravitational direction) by the self-weight of the blocking plate 130. Then, the blocking plate 130 can be more naturally bent in the gravitational direction by the weight provided by the shape maintaining member 170. Accordingly, the blocking plate 130 closes the hollow S while the opposite edges of the blocking plate 130 are naturally seated on the seating seat 113. Then, because the blocking plate 130 is formed of a soft material, noise is not caused even though the opposite sides of the edge of the blocking plate 130 are seated on the seating seat 113. In addition, the blocking plate 130 is provided with a load by the weight of the shape maintaining member 170, and a space between the seating seat 113 and the edge of the blocking plate 130 forms a sealed state because the edge of the blocking plate 130, which is seated on the seating seat 113, forms a pressed state by the load. Accordingly, the blocking plate 130 completely blocks the contaminated air generated on the outside from being introduced into the outside.

The damper for preventing noise according to the present invention can easily discharge the air in an interior (an interior of a room, a bathroom, a kitchen, and the like) to the outside, and can easily block the exterior air from being introduced into the interior.

1. A duct damper comprising:
a housing having a hollow and installed in the interior of a duct such that air ventilates through the housing;
a blocking plate of a soft material, which is provided in the housing to open and close the hollow;
a fastener configured to fix the blocking plate to the housing; and
a shape maintaining member configured to maintain the shape of a soft portion of the blocking plate, which is not fixed by the fastener,
wherein the shape maintaining member includes:
a bar-shaped center bar provided to be long in a line form along a center line direction of the blocking plate on opposite sides of the blocking plate, which are spaced apart from each other by a predetermined interval in a horizontal direction from the center line of the blocking plate to be symmetrical to each other, and configured to provide a reference axis, by which the blocking plate is bent; and
a support bar extending from the center bar to be integrally formed to an edge of the blocking plate and configured to suppressing deformation of the shape of the blocking plate.

2. The duct damper of claim 1, wherein the housing includes:
a seating frame provided in a state in which the seating frame crosses the interior of the housing to be divided into halves and having a predetermined width such that the blocking plate is seated on the seating frame; and
a stepped seating seat protruding along an inner edge of the housing such that an edge of the blocking plate seated on the seating fame is seated on the seating seat.

3. The duct damper of claim 1, wherein the fastener includes:
a plurality of bosses protruding along a lengthwise direction of the seating frame; and
hole-shaped coupling holes formed to pass through the blocking plate to correspond to the coupling bosses and coupled in a state in which the coupling bosses pass through the coupling holes.

4. The duct damper of claim 1, wherein the support bar includes:
a plurality of ribs extending from the center bar to an end of the edge of the blocking plate, radially formed from the center bar, and configured to partially support a surface of the blocking plate.

5. The duct damper of claim 1, wherein the support bar includes:
a rib extending from the center bar along the edge of the blocking plate, provided to have a shape corresponding to the edge of the blocking plate, and configured to support the entire edge of the blocking plate.

6. The duct damper of claim 5, further comprising:
a weight member provided on a surface of the blocking plate that is opposite to a surface of the blocking plate, which is provided with the shape maintaining member, and configured to provide a weight to the blocking plate.

7. The duct damper of claim 6, wherein the blocking plate further includes:
a stepped step formed at a lower end of the edge of the blocking plate as the weight member corresponds to the shape maintaining member and is spaced apart from an inner side of the edge of the blocking plate by a predetermined interval.

8. The duct damper of claim 2, further comprising:
a net-shaped auxiliary frame formed in the interiors of opposite sides of the housing divided by the seating frame and configured to support a lower portion of the blocking plate to prevent reverse movement of the blocking plate.
